(19) United States
(12) Patent Application Publication
(10) Pub. No.: US 2026/0264621 A1
(43) Pub. Date: Sep. 10, 2026

(54) Vehicle Headrest Concealed Firearm Storage Device

(71) Applicant: Robert Phipps, McMinnville, OR (US)

(72) Inventor: Robert Phipps, McMinnville, OR (US)

(21) Appl. No.: 19/214,663

(22) Filed: May 21, 2025

Related U.S. Application Data
(60) Provisional application No. 63/767,716, filed on Mar. 6, 2025.

(51) Int. Cl. B60R 7/14; B60N 2/818; B60N 2/879; B60R 7/04; F41C 33/06

(52) U.S. Cl. CPC B60R 7/14; B60N 2/818; B60N 2/879; B60R 7/043; F41C 33/06

(57) ABSTRACT

A vehicle headrest concealed firearm storage device is provided. The device is comprised of a body configured to replace a standard vehicle seat headrest, wherein the body comprises an outermost upholstery layer, an internal padding layer, and a rigid shell defining a concealed cavity. The cavity houses a precision-cut foam insert dimensioned to receive and retain a firearm, and may further comprise an elastic retention band for additional stabilization. The rigid shell provides structural integrity, while the foam insert is configured to conform to specific firearm shapes to prevent lateral motion. The body is supported by a pair of telescoping support posts with detents that interface with locking mechanisms in the vehicle seat frame. A concealed fastener mechanism provides access to the cavity and may comprise a reverse-coil zipper hidden beneath a fabric flap. The flap is magnetically retained against the body using embedded magnets to prevent visible disturbance.

### CROSS-REFERENCE TO RELATED APPLICATION

The present application claims priority to, and the benefit of, U.S. Provisional Application No. 63/767,716, which was filed on Mar. 6, 2025, and is incorporated herein by reference in its entirety.

### FIELD OF THE INVENTION

The present invention relates generally to the field of firearm vehicle storage devices. More specifically, the present invention relates to a vehicle headrest that can conceal and store a firearm. Accordingly, the present disclosure makes specific reference thereto. Nonetheless, it is to be appreciated that aspects of the present invention are also equally applicable to other like applications, devices, and methods of manufacture.

### BACKGROUND

Individuals who carry firearms in their vehicles often store them either in holsters mounted on their person or inside compartments such as glove boxes. These conventional storage methods present a number of challenges. Retrieving a firearm quickly during an emergency may be hindered by difficult access or obstructive placement. A firearm stored in a glove compartment may shift during vehicle motion, potentially causing damage to both the firearm and surrounding objects. Additionally, glove compartments are commonly targeted during vehicle break-ins, increasing the likelihood of firearm theft. Visibility of the firearm or its case within the compartment can also draw attention, compromising discretion. On-person holsters can be uncomfortable during extended travel or may interfere with seat belts and other restraints. These limitations create both security and accessibility concerns for firearm owners. Consequently, there exists a need for an alternative storage solution that is both hidden and readily accessible when needed.

Therefore, there exists a long-felt need in the art for a vehicle headrest concealed firearm storage device that provides discreet and hidden firearm storage integrated into a standard vehicle headrest. There also exists a long-felt need in the art for a vehicle headrest concealed firearm storage device that securely holds a firearm in place to prevent unwanted movement during vehicle operation. Moreover, there exists a long-felt need in the art for a vehicle headrest concealed firearm storage device that allows rapid access to the firearm while maintaining the external appearance and functionality of a conventional headrest.

The subject matter disclosed and claimed herein, in one embodiment thereof, comprises a vehicle headrest concealed firearm storage device. The device is comprised of a body configured to replace a standard vehicle seat headrest, wherein the body comprises an outermost upholstery layer, an internal padding layer, and a rigid shell defining a concealed cavity. The cavity houses a precision-cut foam insert dimensioned to receive and retain a firearm, and may further comprise an elastic retention band for additional stabilization. The rigid shell provides structural integrity, while the foam insert is configured to conform to specific firearm shapes to prevent lateral motion. The body is supported by a pair of telescoping support posts with detents that interface with locking mechanisms in the vehicle seat frame, allowing vertical positioning. A concealed fastener mechanism provides access to the cavity and may comprise a reverse-coil zipper hidden beneath a fabric flap. The flap is magnetically retained against the body using embedded magnets to prevent visible disturbance. The outermost layer is selected to match vehicle interior finishes, ensuring the device remains inconspicuous. The fastener mechanism is further positioned to remain hidden from view under standard lighting and observational conditions.

In this manner, the vehicle headrest concealed firearm storage device of the present invention accomplishes all the foregoing objectives and provides a concealed, integrated storage solution that maintains the original appearance of a vehicle headrest while discreetly housing a firearm. The combination of a precision-molded foam insert and optional elastic retention ensures secure storage without firearm displacement during travel. The fast-access design further allows the authorized user to retrieve the firearm quickly without compromising discretion or visual concealment. In addition, the materials and form factor preserve the aesthetic, ergonomic, and safety features expected of an OEM headrest, making the device a practical solution for secure and accessible in-vehicle firearm storage.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle headrest concealed firearm storage device. The device is comprised of a concealed storage system that replaces a standard vehicle headrest, internally securing a firearm while maintaining the appearance, comfort, and safety functions of a conventional automotive headrest. The design enhances firearm accessibility for authorized users without altering the vehicle's interior aesthetics.

The device is comprised of a body that replicates standard headrest shapes and dimensions, incorporating an outermost layer, a padding layer, and an internal rigid shell. The outermost layer is comprised of upholstery materials matching original vehicle specifications, while the padding layer preserves tactile comfort using compressible, resilient materials. The internal rigid shell provides structural integrity and includes a cavity dimensioned for firearm storage.

The cavity is comprised of a receiving area formed by a precision-cut foam insert made from oil-resistant, vibration-dampening materials. The insert is shaped to conform to one or more firearm models, securing the firearm via elastic compression or alternative retention systems such as mechanical or polymer-based configurations. An elastic retention band may further stabilize the firearm during vehicle motion.

The body is mounted to the vehicle seat using telescoping support posts with detents that engage with seat frame locking mechanisms, allowing vertical adjustment. A concealed fastener mechanism, such as a reverse-coil zipper, provides access to the internal cavity. The fastener is hidden beneath a fabric flap matching the outermost layer, retained by magnets embedded within the body and flap. Alternative closure systems may be used, provided they remain visually and tactilely inconspicuous.

A method of using the device includes mounting the device to a vehicle seat, accessing the internal cavity via the concealed fastener, placing a firearm into the foam insert, and securing it with the elastic band, then resealing and concealing the cavity. The device then functions as a standard headrest while discreetly storing the firearm.

Accordingly, the vehicle headrest concealed firearm storage device of the present invention is particularly advantageous as it provides a concealed, integrated storage solution that maintains the original appearance of a vehicle headrest while discreetly housing a firearm. The combination of a precision-molded foam insert and optional elastic retention ensures secure storage without firearm displacement during travel. The fast-access design further allows the authorized user to retrieve the firearm quickly without compromising discretion or visual concealment. In addition, the materials and form factor preserve the aesthetic, ergonomic, and safety features expected of an OEM headrest, making the device a practical solution for secure and accessible in-vehicle firearm storage. In this manner, the vehicle headrest concealed firearm storage device overcomes the limitations of existing vehicle firearm storage solutions known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vehicle headrest concealed firearm storage device of the present invention with the concealed fastener and flap closed in accordance with the disclosed architecture;

FIG. 2 illustrates a perspective view of one potential embodiment of a vehicle headrest concealed firearm storage device of the present invention with the concealed fastener and flap open in accordance with the disclosed architecture;

FIG. 3 illustrates a perspective view of one potential embodiment of a vehicle headrest concealed firearm storage device of the present invention, with the concealed fastener and flap open, and while the receiving area of the internal cavity is receiving a firearm in accordance with the disclosed architecture; and

FIG. 4 illustrates a flowchart of a method of using one potential embodiment of a vehicle headrest concealed firearm storage device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a vehicle headrest concealed firearm storage device that provides discreet and hidden firearm storage integrated into a standard vehicle headrest. There also exists a long-felt need in the art for a vehicle headrest concealed firearm storage device that securely holds a firearm in place to prevent unwanted movement during vehicle operation. Moreover, there exists a long-felt need in the art for a vehicle headrest concealed firearm storage device that allows rapid access to the firearm while maintaining the external appearance and functionality of a conventional headrest.

The present invention, in one exemplary embodiment, is comprised of a vehicle headrest concealed firearm storage device. The device is comprised of a concealed storage system designed to replace a standard vehicle headrest, enabling internal firearm storage while preserving the appearance, comfort, and safety functions associated with conventional automotive headrests. Further, the device improves firearm accessibility for authorized users without altering the interior aesthetics of the vehicle.

The device is comprised of a body replicating the shape and dimensions of typical headrests, including an outermost layer, a padding layer, and an internal rigid shell. The outermost layer is comprised of upholstery materials selected to match the original vehicle specifications. The padding layer maintains tactile comfort using compressible, resilient materials. The internal rigid shell provides structural integrity and contains a cavity configured for firearm storage.

The cavity is comprised of a receiving area formed by a precision-cut foam insert fabricated from oil-resistant, vibration-dampening materials. The insert is contoured to match the shape of one or more firearm models and secures the firearm by elastic compression or other retention methods, including mechanical or polymer-based systems. An elastic retention band may be included to further stabilize the firearm during vehicle motion.

The body is attached to the vehicle seat via telescoping support posts featuring detents that engage seat frame locking mechanisms for vertical adjustment. Access to the internal cavity is provided by a concealed fastener mechanism, such as a reverse-coil zipper, positioned beneath a fabric flap that matches the outermost layer. The flap is held in place by magnets embedded in both the body and the flap. Alternative fastener designs may be used, provided they remain visually and tactilely unobtrusive.

A method of use involves mounting the device to a vehicle seat, opening the concealed fastener to access the internal cavity, placing a firearm into the foam insert, securing it with the elastic band, resealing the cavity, and repositioning the flap. Once closed, the device functions as a conventional headrest while discreetly storing the firearm.

Therefore, the vehicle headrest concealed firearm storage device offers a discreet, integrated solution that maintains the original appearance of a vehicle headrest while securely housing a firearm. The combination of a precision-molded foam insert and an optional elastic retention band ensures firearm stability during travel. The quick-access design allows for efficient retrieval by authorized users without compromising concealment. Furthermore, the materials and structure uphold the ergonomic, aesthetic, and safety standards expected of an OEM headrest, presenting a practical and secure method for in-vehicle firearm storage that addresses limitations of prior solutions.

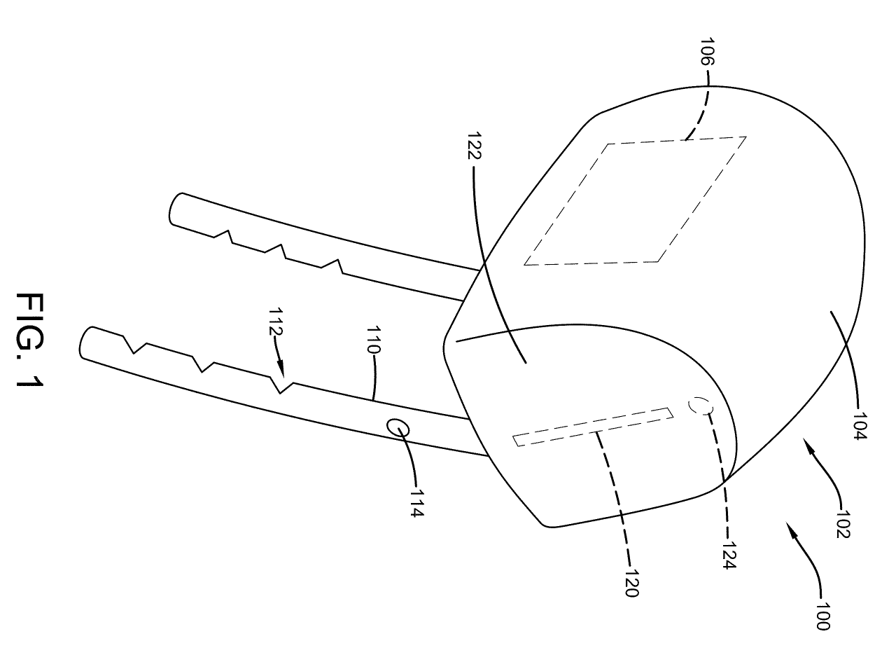

Referring initially to the drawings, FIG. 1 illustrates a perspective view of one potential embodiment of a vehicle headrest concealed firearm storage device 100 of the present invention with the concealed fastener and flap closed in accordance with the disclosed architecture. The device 100 is comprised of a concealed storage solution designed to replace the headrest of a vehicle seat. The device 100 further internally secures a firearm while preserving the visual, ergonomic, and functional characteristics associated with a standard automotive headrest. As such, the device 100 may enhance stealth and accessibility for authorized users without disrupting the expected appearance, comfort, or safety functions of conventional vehicle headrests.

The device 100 may be comprised of a body 102. The body 102 may be any style, shape, or dimension of vehicle headrests, including, but not limited to, rectangular, contoured, or ergonomically curved headrests. The body 102 may be comprised of an outermost layer 104, a padding layer 106, and an internal rigid shell 108. The outermost layer 104 may be comprised of upholstery material selected to match original equipment manufacturer (OEM) specifications. Materials may include, but are not limited to, leather, synthetic leather, cloth, vinyl, Alcantara, or polymer-coated textiles. The material selection for the outermost layer 104 may be chosen to align with the adjacent seat design, color scheme, and interior aesthetic of the host vehicle.

The padding layer 106 may be positioned immediately beneath the outermost layer 104 and may serve to preserve the tactile comfort and compressibility of a standard headrest. The padding layer 106 may be comprised of materials such as, but not limited to, polyurethane foam, memory foam, open-cell foam, viscoelastic polymers, or other resilient padding materials capable of absorbing compressive forces.

Enclosed within the padding layer 106, a rigid shell 108 may provide the structural integrity required for safe storage of a firearm. The rigid shell 108 may be comprised of injection-molded polymer, thermoplastic composite, fiberglass-reinforced plastic, and/or a metal alloy such as aluminum or stainless steel, selected for its combination of strength, weight, and resistance to deformation. The shell 108 may be comprised of an internal cavity 115 dimensioned to accommodate a firearm.

The internal cavity 115 may house a receiving area 116, preferably in the form of a precision-cut foam insert. The foam insert 116 may be comprised of materials such as high-density ethylene-vinyl acetate (EVA), polyethylene foam, closed-cell nitrile rubber, or other oil-resistant, vibration-dampening materials. The foam insert 116 may be cut or molded to conform to the specific contours of one or more firearm models, ensuring a secure fit. In addition to conformal shaping, the foam insert 116 may secure the firearm by means of elastic compression. In other embodiments, the receiving area 116 may include, but is not limited to, a mechanical retention system, a polymer retention system, a textile-based retention system, an elastomeric retention system, etc.

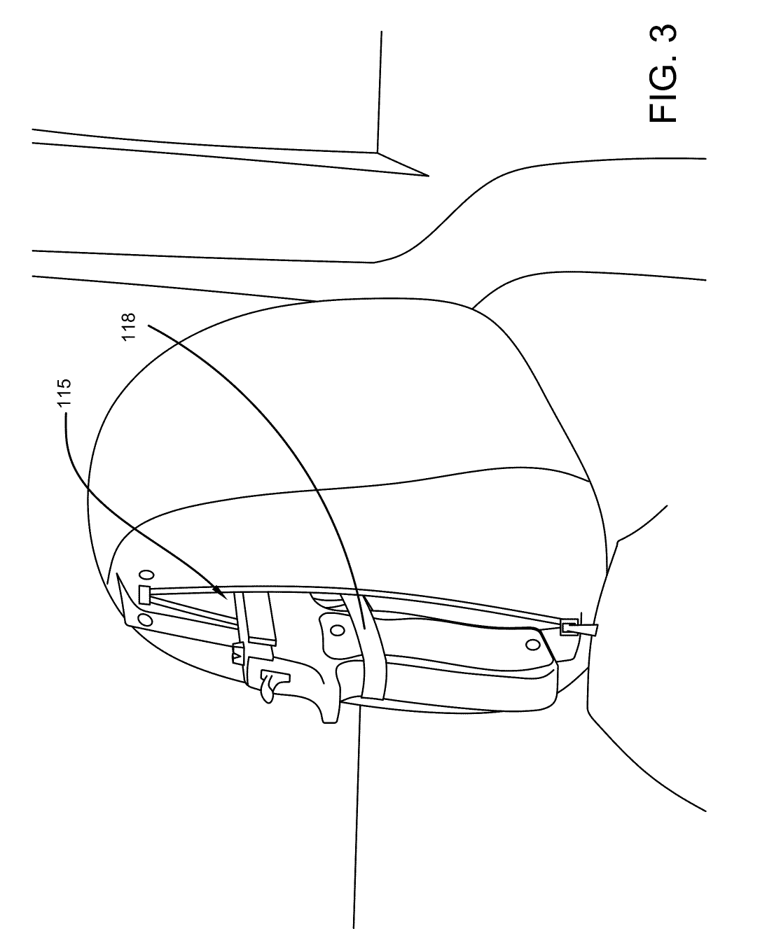

To provide secondary retention, at least one elastic retention band 118 may be integrated within the cavity 115, as seen in FIG. 3. The retention band 118 may be comprised of woven elastic, thermoplastic elastomer, or hook-and-loop equipped fabric. The retention band 118 may extend over specific regions of the firearm to further stabilize the position of the firearm during dynamic vehicle motion.

The body 102 may be mounted to a vehicle seat using a pair of support posts 110. Each support post 110 may include a series of detents 112 to facilitate incremental vertical adjustment. The detents 112 may interact with integrated locking mechanisms within the seat frame to allow secure positioning. A release button 114 may be incorporated into one or both posts 110 to permit manual repositioning of the device 100 along the vertical axis.

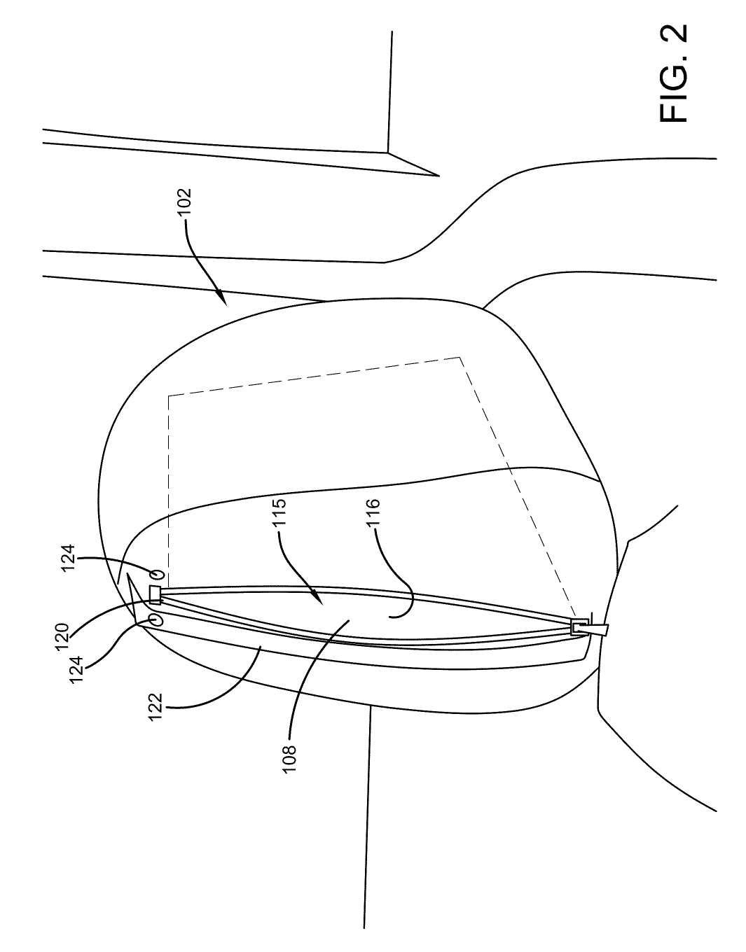

Access to the internal cavity 115 may be provided through a concealed fastener mechanism 120 integrated into the body 102. In one embodiment, the fastener mechanism 120 may be comprised of a reverse-coil zipper, as seen in FIG. 2. The reverse-coil design may conceal the zipper teeth on the interior side of the closure track, thereby minimizing surface irregularities and improving visual camouflage.

The fastener 120 may be concealed beneath a flap 122, which may be fabricated from the same material as the outermost layer 104 to provide seamless visual continuity. The flap 122 may be attached along one edge to the body 102 and may fully overlay the fastener 120. The flap 122 may be retained in place by a distributed array of magnets 124 embedded within the structure of the body 102 and the inner surface of the flap 122, as seen in FIG. 2. The magnets 124 may be spaced at intervals along the flap 122 length to ensure uniform magnetic adhesion and prevent any unintended lifting or sagging. Alternative fastener mechanisms 120 may include, but are not limited to, micro snap closures, silent hook-and-loop systems, magnetic latches, mechanical locking mechanisms, etc. However, in all configurations, the fastener mechanism 120 may be oriented and integrated to remain visually and tactilely inconspicuous during normal viewing conditions, including daylight, low light, and casual inspection.

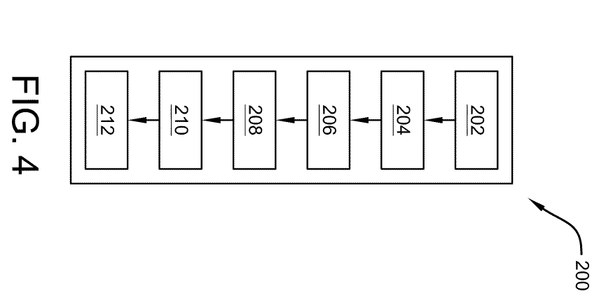

The present invention is also comprised of a method of using 200 the device 100, as seen in FIG. 4. First, a device 100 is provided comprised of a body 102 comprised of an outermost layer 104, a padding layer 106, an internal rigid shell 108, at least one internal cavity 115, and at least one concealed fastener mechanism 120 [Step 202]. Then, the body 102 can be attached to a vehicle seat by inserting a pair of telescoping support posts 110 into corresponding headrest mounts in the seat frame, wherein detents 112 engage with integrated locking mechanisms to enable secure vertical positioning [Step 204]. Next, a user can access the internal cavity 115 by lifting a flap 122 that overlays the concealed fastener mechanism 120 and opening the fastener mechanism 120, such as a reverse-coil zipper, to reveal the interior storage compartment [Step 206]. A firearm can then be inserted into the receiving area 116 within the cavity 115, wherein the receiving area 116 is comprised of a precision-cut foam insert conforming to the firearm’s shape and at least one elastic retention band 118 securing the firearm in place [Step 208]. Next, the fastener mechanism 120 can be closed to seal the cavity 115, and the flap 122 can be repositioned to conceal the fastener mechanism 120, wherein the flap 122 is magnetically retained by an array of embedded magnets 124 [Step 210]. Finally, the device 100 may be used as a conventional vehicle headrest while maintaining stealth firearm storage functionality [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle headrest concealed firearm storage device” and “device” are interchangeable and refer to the vehicle headrest concealed firearm storage device 100 of the present invention.

Notwithstanding the foregoing, the vehicle headrest concealed firearm storage device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vehicle headrest concealed firearm storage device 100 as shown in the FIGS. are for illustrative purposes only, and that many other sizes and shapes of the vehicle headrest concealed firearm storage device 100 are well within the scope of the present disclosure. Although the dimensions of the vehicle headrest concealed firearm storage device 100 are important design parameters for user convenience, the vehicle headrest concealed firearm storage device 100 may be of any size, shape, and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle headrest concealed firearm storage device comprising:
a body configured in the shape of a vehicle headrest;
an outermost layer comprised of upholstery material;
a padding layer positioned beneath the outermost layer;
an internal rigid shell enclosed within the padding layer, an internal cavity formed within the rigid shell and dimensioned to accommodate a firearm;
a receiving area disposed within the internal cavity and configured to secure the firearm; and
a concealed fastener mechanism integrated into the body to provide access to the internal cavity.

2. The vehicle headrest concealed firearm storage device of claim 1, wherein the receiving area comprises a foam insert conforming to the shape of the firearm.

3. The vehicle headrest concealed firearm storage device of claim 1, wherein the concealed fastener mechanism is a reverse-coil zipper.

4. The vehicle headrest concealed firearm storage device of claim 1 further comprising a flap overlaying the concealed fastener.

5. The vehicle headrest concealed firearm storage device of claim 4, the flap and an outer layer of the body are made from the same material.

6. The vehicle headrest concealed firearm storage device of claim 4, wherein the flap is magnetically retained to the body by a magnet.

7. The vehicle headrest concealed firearm storage device of claim 1 further comprising an elastic retention band.

8. The vehicle headrest concealed firearm storage device of claim 5, wherein the outer layer of the body is comprised of a leather, a synthetic leather, a cloth, a vinyl, an Alcantara, or a polymer-coated textile.

9. The vehicle headrest concealed firearm storage device of claim 1, wherein the receiving area is comprised of a high-density ethylene-vinyl acetate, a polyethylene foam, a closed-cell nitrile rubber, or a vibration-dampening material.

10. The vehicle headrest concealed firearm storage device of claim 1, wherein the padding layer is comprised of a polyurethane foam, a memory foam, an open-cell foam, a viscoelastic polymers, or a resilient padding material.

11. A vehicle headrest concealed firearm storage device comprising:
a body configured in the shape of a vehicle headrest;
an outermost layer comprised of upholstery material;
a padding layer positioned beneath the outermost layer;
an internal rigid shell enclosed within the padding layer, an internal cavity formed within the rigid shell and dimensioned to accommodate a firearm;
a pair of support posts;
a receiving area disposed within the internal cavity and configured to secure the firearm; and
a concealed fastener mechanism integrated into the body to provide access to the internal cavity.

12. The vehicle headrest concealed firearm storage device of claim 11 further comprised of a release button.

13. The vehicle headrest concealed firearm storage device of claim 11 further comprising an elastic retention band.

14. The vehicle headrest concealed firearm storage device of claim 11, wherein the receiving area comprises a foam insert conforming to the shape of the firearm.

15. The vehicle headrest concealed firearm storage device of claim 11, wherein the concealed fastener mechanism is a reverse-coil zipper.

16. The vehicle headrest concealed firearm storage device of claim 11 further comprising a flap overlaying the concealed fastener.

17. The vehicle headrest concealed firearm storage device of claim 16, the flap and an outer layer of the body are made from the same material.

18. The vehicle headrest concealed firearm storage device of claim 16, wherein the flap is magnetically retained to the body by a magnet.

19. The vehicle headrest concealed firearm storage device of claim 17, wherein the outer layer of the body is comprised of a leather, a synthetic leather, a cloth, a vinyl, an Alcantara, or a polymer-coated textile.

20. A method of using a vehicle headrest concealed firearm storage device, the method comprising the following steps:
providing a vehicle headrest concealed firearm storage device comprised of a body configured in the shape of a vehicle headrest, the body comprised of an outermost layer, a padding layer, an internal rigid shell, an internal cavity formed within the internal rigid shell and dimensioned to accommodate a firearm, a receiving area disposed within the internal cavity and configured to secure the firearm, and a concealed fastener mechanism integrated into the body to provide access to the internal cavity;
attaching the body to a vehicle seat by inserting a pair of telescoping support posts of the vehicle headrest concealed firearm storage device into a headrest mount in a vehicle seat frame;
accessing the internal cavity by lifting a flap that overlays the concealed fastener mechanism and opening the concealed fastener mechanism;
inserting a firearm into the receiving area;
closing the concealed fastener mechanism;
repositioning the flap to conceal the concealed fastener mechanism; and
using the vehicle headrest concealed firearm storage device as a vehicle headrest.
